(19) United States
(12) Patent Application Publication
(10) Pub. No.: US 2010/0271300 A1
(43) Pub. Date: Oct. 28, 2010

(54) Multi-Touch Pad Control Method

(75) Inventors: Chung-Wen Hsu, Kaohsiung (TW); Ke-Wei Chen, Hsin-Chu (TW)

Correspondence Address: SQUIRE, SANDERS & DEMPSEY L.L.P., 275 BATTERY STREET, SUITE 2600, SAN FRANCISCO, CA, 94111-3356, US

(73) Assignee: WALTOP INTERNATIONAL CORPORATION, Hsinchu (TW)

(21) Appl. No.: 12/580,034

(22) Filed: Oct. 15, 2009

(30) Foreign Application Priority Data
Apr. 23, 2009 (TW) 098113471

(51) Int. Cl. G06F 3/041; G06F 3/033

(52) U.S. Cl. 345/158; 345/173

(57) ABSTRACT

A multi-touch pad control method is disclosed. The method comprises the following steps. First of all, a primary cursor is detected. Then a first touch motion is detected, if there is no first touch motion, primary cursor is re-detected. Next a secondary cursor is detected if there is a first touch motion. Then a second touch motion is detected. A first function is performed if there is no second touch motion. A first direction of the second touch motion is detected, if the second touch motion controlling the secondary cursor is detected. A second function is performed if the second touch motion is toward first direction. A second direction of the second touch motion is detected, if the second touch motion is not toward the first direction. A third function is performed if the second touch motion is toward the second direction, wherein the first function is performed if the second touch motion controlling the secondary cursor is detected and the second touch motion is neither toward the first direction nor the second direction.

### 1. FIELD OF THE INVENTION

The present invention relates to a multi-touch pad control method, and more particularly to a multi-touch pad control method which can judge and react according user's gesture.

### 2. DESCRIPTION OF THE PRIOR ART

Touch pads are widely used as input, directional and control devices in various electronic appliances. Conventional touch pads can only accept one touch instruction/command from user's finger at one time, and follow the trace of user' finger on the touch pad to control and move a cursor on a display screen. Conventional touch pads usually further include two buttons corresponding to that of mice as selection function keys. Multi-touch technology was developed for various new applications and was applied on touch pads. Conventional multi-touch pads utilizes piezoelectric touch sensor or capacitive touch sensor technologies to simultaneously sense and detect multiple touch input signals.

Touch pads are usually included as a part of notebook PC and used as an input device together with a mouse to control a cursor on a display screen or user interface of application program. It would be inconvenience if users simultaneously use a digital tablet to input texts or drawings by using an electromagnetic pen and a mouse to control a cursor on a display screen or user interface of application program and increase loading of the users and complexity of input devices.

In order to simplify, integrate input device of electronic appliance, and to enhance performance and function of multi-touch pad, the invention provides a multi-touch pad control method to automatically judge and determine the trace and direction of cursor, and gesture of user. A primary touch motion of a user can control the movement of a cursor to replace a mouse, and a secondary touch motion can be set with functions the same with that of the buttons of the mouse to replace the right and left buttons of the mouse.

### SUMMARY OF THE INVENTION

An object of the present invention is to provide a multi-touch pad control method to automatically determine the trace and direction of cursor, and simulate or speculate the gesture of user. A primary touch motion of a user can control the movement of a cursor to replace a mouse, and a secondary touch motion can be set with functions the same with that of the buttons of the mouse to replace the right and left buttons of the mouse.

According to the object, one embodiment of the present invention provides a multi-touch pad control method, the method comprises the following steps. First of all, a primary cursor is detected. Then a first touch motion on a touch pad is detected. The primary cursor is re-detected if there is no touch motion. Next a secondary cursor is detected if there is a touch motion. Then a second touch motion on the touch pad is detected. Next a first function is performed if there is no second touch motion detected. A first direction of the second touch motion is detected if the second touch motion controlling the secondary cursor is detected. A second function is performed if the second touch motion is toward the first direction. A second direction of the second touch motion is detected if the second touch motion is not toward the first direction. A third function is performed if the second touch motion is toward the second direction, wherein the first function is performed if the second touch motion controlling the secondary cursor is detected and the second touch motion is neither toward the first direction nor the second direction.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 shows two examples of electronic appliances, which can utilize one embodiment of the multi-touch pad control method of the invention.

FIG. 2 shows one embodiment of a computer system, which can utilize one embodiment of the multi-touch pad control method of the invention.

FIG. 3 shows a flow chart of one embodiment of the multi-touch pad control method of the invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

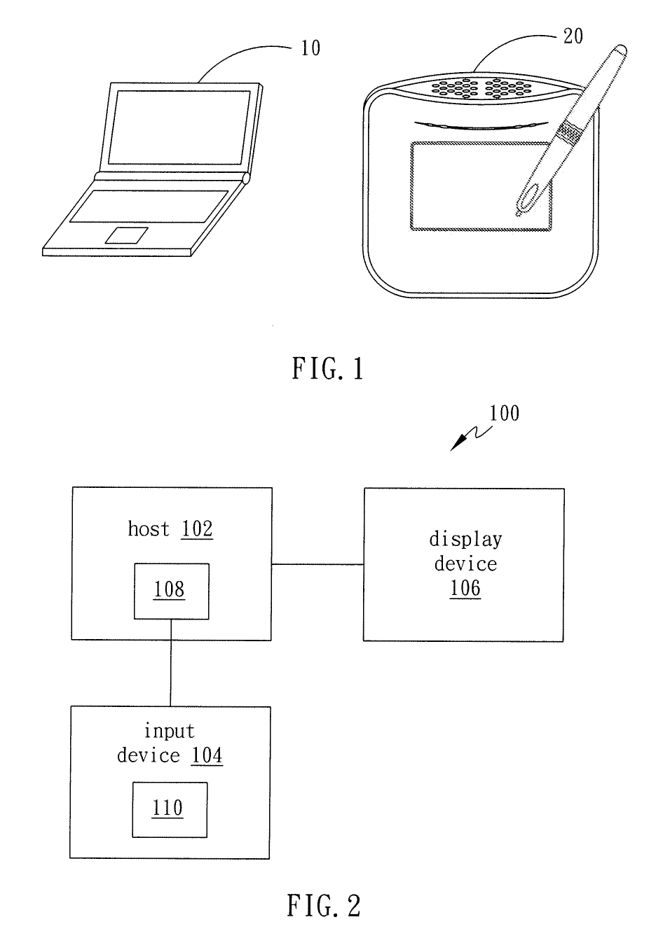

FIG. 1 shows two examples of electronic appliances, which can utilize one embodiment of the multi-touch pad control method of the invention. The electronic appliances comprise, but not limited to, a notebook/laptop personal computer 10 and a digital tablet 20, and the multi-touch pad control method of the invention can be applied to any device or apparatus which includes or use a digital tablet or a multi-touch pad. FIG. 2 shows one embodiment of a computer system, which can utilize one embodiment of the multi-touch pad control method of the invention. The computer system 100 includes a host 102, an input device 104 and a display device 106. The host 102 comprises a driver module 108 to drive the input device 104. The driver module 108 comprises hardware, firmware and/or software driver program in the host 102 or the input device 104. The input device 104 includes a touch surface 110. The input device 104 comprises a touch pad of a notebook/laptop personal computer or a writing pad or a touch pad of a digital tablet or a multi-touch pad. The display device 106 includes a LCD display or screen. User inputs or controls a cursor or user interface of application program shown on the display device 106 through the touch surface 110.

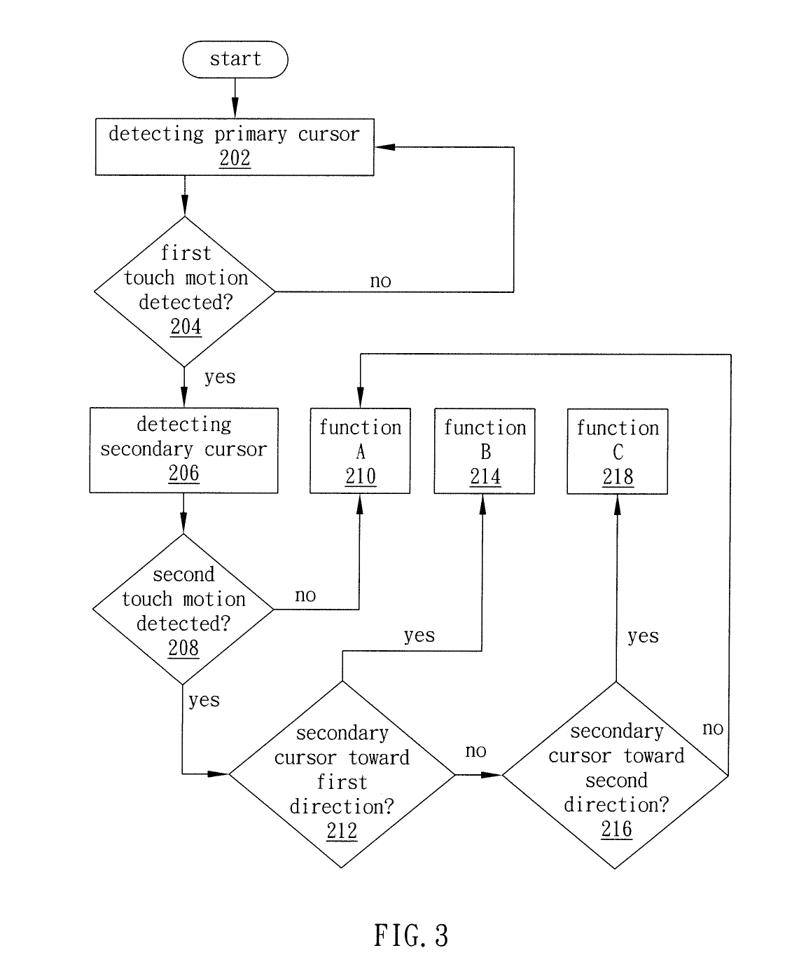

FIG. 3 shows a flow chart of one embodiment of the multi-touch pad control method of the invention. First of all, a primary cursor is detected in step 202. In one embodiment, the detecting of the primary cursor is performed by the driver module 108 or application program in the computer system 100. Then a first touch motion on a touch pad is detected in step 204. The touch motion is detected by a touch sensor circuit (not shown) under the touch surface 110 of the computer system 100. The touch sensor circuit then informs the driver module 108 or application programs in the computer system 100 the detection of the touch motion. If there is no touch motion, the primary cursor is re-detected. Next a secondary cursor is detected in step 206 if there is a touch motion. In one embodiment, the detecting of the secondary cursor is performed by the driver module 108 or application program in the computer system 100. Then a second touch motion is detected in step 208. The second touch motion is detected by a touch sensor circuit under the touch surface 110 of the computer system 100. The touch sensor circuit then informs the driver module 108 or application programs in the computer system 100 the detection of the second touch motion. A first function A is performed in step 210 if there is no second touch motion detected. The first function A comprises moving a cursor on a display device similar to control a cursor by using a mouse. A first direction of the second touch motion is detected in step 212, if the second touch motion controlling the secondary cursor is detected. The first direction of the second touch motion is detected by a touch sensor circuit under the touch surface 110 of the computer system 100. The touch sensor circuit then informs the driver module 108 or application programs in the computer system 100 the detection of the first direction of the second touch motion. A second function B is performed in step 214 if the second touch motion is toward the first direction. The second function B comprises a button function similar to a button function of a mouse. A second direction of the second touch motion is detected in step 216, if the second touch motion is not toward the first direction. The second direction of the second touch motion is detected by a touch sensor circuit under the touch surface 110 of the computer system 100. The touch sensor circuit then informs the driver module 108 or application programs in the computer system 100 the detection of the second direction of the second touch motion. A third function C is performed in step 218 if the second touch motion is toward the second direction. The third function C comprises a second button function similar to a second button function of a mouse. The first function A is performed in step 210 if the second touch motion controlling the secondary cursor is detected and the second touch motion is neither toward the first direction nor the second direction. The first function A comprises moving a cursor, and the second function B and the third function C comprise a first button function and a second button function of a mouse respectively. The setting of the second function B and the third function C can be performed by firmware or software driver program in the host 102 or the input device 104. In one embodiment, the multi-touch pad control method of the invention is performed by firmware or software driver program in the host 102 or the input device 104. The software driver program can be programmed by programming languages including C/C+, assembly. The firmware or software driver program are stored in a computer readable medium. The computer readable medium stores processor executable instructions or programs. The computer readable medium comprises hard drives, memory devices or other medium.

One embodiment of the multi-touch pad control method of the invention is performed by multi-finger operation of a user, wherein a first finger touches a touch pad to simulate a first button function of a mouse, a second finger controls a cursor to simulate the control of the mouse, and a third finger touches the touch pad to simulate a second button function of the mouse. The multi-touch pad control method of the invention judges and determines the directions of a primary and a secondary cursor according to the gesture of the user on the multi-touch pad by firmware or software driver program. The determination of user's gesture from either hand can be set through the firmware or software driver program.

Although specific embodiments have been illustrated and described, it will be appreciated by those skilled in the art that various modifications may be made without departing from the scope of the present invention, which is intended to be limited solely by the appended claims.

What is claimed is:

1. A multi-touch pad control method, said method comprising:
detecting a primary cursor;
detecting a first touch motion on a touch pad;
re-detecting the primary cursor if there is no touch motion;
detecting a secondary cursor if there is a touch motion;
detecting a second touch motion on the touch pad;
performing a first function if there is no second touch motion detected;
detecting a first direction of the second touch motion if the second touch motion controlling the secondary cursor is detected.
performing a second function if the second touch motion is toward the first direction;
detecting a second direction of the second touch motion if the second touch motion is not toward the first direction; and
performing a third function if the second touch motion is toward the second direction, wherein the first function is performed if the second touch motion controlling the secondary cursor is detected and the second touch motion is neither toward the first direction nor the second direction.

2. The method according to claim 1, wherein the touch pad comprises a touch pad of a digital tablet.

3. The method according to claim 1, wherein the touch pad comprises a touch pad of a notebook/laptop personal computer.

4. The method according to claim 1, wherein the touch pad comprises a writing pad of a digital tablet.

5. The method according to claim 1, wherein the first function comprises moving a cursor.

6. The method according to claim 1, wherein the second function and the third function comprise a first button function and a second button function of a mouse respectively

7. A computer readable medium storing processor executable instructions operable to perform a multi-touch pad control method, said method comprising:
detecting a primary cursor;
detecting a first touch motion on a touch pad;
re-detecting the primary cursor if there is no touch motion;
detecting a secondary cursor if there is a touch motion;
detecting a second touch motion on the touch pad;
performing a first function if there is no second touch motion detected;
detecting a first direction of the second touch motion if the second touch motion controlling the secondary cursor is detected.
performing a second function if the second touch motion is toward the first direction;
detecting a second direction of the second touch motion if the second touch motion is not toward the first direction; and
performing a third function if the second touch motion is toward the second direction, wherein the first function is performed if the second touch motion controlling the secondary cursor is detected and the second touch motion is neither toward the first direction nor the second direction.

8. The method according to claim 7, wherein the touch pad comprises a writing pad of a digital tablet.

9. The method according to claim 7, wherein the first function comprises moving a cursor.

10. The method according to claim 7, wherein the second function and the third function comprise a first button function and a second button function of a mouse respectively
